(19) United States
(12) Patent Application Publication
(10) Pub. No.: US 2026/0073947 A1
(43) Pub. Date: Mar. 12, 2026

(54) RECORDING DEVICE

(71) Applicant: NHK SPRING CO., LTD., Yokohama-shi, Kanagawa (JP)

(72) Inventors: Yusuke TANABE, Yokohama-shi, Kanagawa (JP); Shuji TAKAHASHI, Yokohama-shi, Kanagawa (JP)

(21) Appl. No.: 18/719,536

(22) PCT Filed: Dec. 14, 2022
(86) PCT No.: PCT/JP2022/046090

§ 371 Date: May 19, 2025

(30) Foreign Application Priority Data
Dec. 22, 2021 (JP) 2021-208588

(51) Int. Cl. G11B 33/12; G11B 33/02

(52) U.S. Cl. CPC G11B 33/12; G11B 33/027

(57) ABSTRACT

Provided is a recording device capable of preventing inclination of a spindle shaft. It includes a base 7 accommodating a disk 5, a cover 9 attached to the base 7, a spindle shaft 15 rotatably supporting the disk 5, one side in an axial direction of which is fixed to the base 7 and the other side in the axial direction of which is fixed to the cover 9, and a screw 19 fixing the other side of the spindle shaft 15 in the axial direction to the cover 9 by fastening and having a screw head portion 19 that contacts a fastened portion 25 of the cover 9, wherein one or both of the screw head portion 19 and the fastened portion 25 have inclined faces 27a, 27b inclined relative to a fastening direction of the screw 19, and the screw head portion 21 and the fastened portion 25 engage with each other through contact at the inclined faces 27a, 27b in an intersecting direction relative to the fastening direction.

### FIELD OF THE INVENTION

The present invention relates to a recording device such as a hard disk drive.

### BACKGROUND OF THE INVENTION

As a conventional recording device, there is a disk device in which heads are positioned to rotating disks as recording media to read and write information as disclosed in Patent document 1, for example. In the disk device, rotation of the disks is conducted by a spindle motor.

The spindle motor is provided with a spindle shaft fixed to a housing composed of a base and a cover, and a plurality of the disks are rotatably supported by the spindle shaft through a hub in a stacked state.

In the fixing of the spindle shaft, one side of the spindle shaft in an axial direction is fixed to a boss portion integrated with the base, and the other side of the spindle shaft in the axial direction is fixed by fastening with a screw in an abutted state to the cover. With this structure, both sides of the spindle shaft are easily fixed to the base and the cover.

The other side of the spindle shaft in the axial direction is, however, held in a fixed state by frictional force with respect to the cover based on the fastening with the screw. Accordingly, if force exceeding the frictional force acts by impact in an intersecting direction relative to the axial direction, the fixed state is not held and there is a risk to incline the spindle shaft.

If the spindle shaft is inclined, positioning accuracy of the heads to the disks is reduced and there is a problem to affect read and write of information.

Such a problem may be caused in the other recording device such as a tape-embedded-type drive of Patent document 2 rotatably supporting a recording medium around a spindle shaft.

### CITATION LIST

### Patent Literature

PATENT LITERATURE 1: JPH10-125053A

PATENT LITERATURE 2: JP2020-129424A

### SUMMARY OF THE INVENTION

### Problems to be Solved by the Invention

A problem to be solved is that a spindle shaft is tend to be inclined.

### Means for Solving the Problem

The present invention provides a recording device comprising a base accommodating a recording medium, a cover attached to the base, a spindle shaft rotatably supporting the recording medium, one side in an axial direction of which is fixed to the base and the other side in the axial direction of which is fixed to the cover, and a fastener fixing said other side of the spindle shaft in the axial direction to the cover by fastening and having a fastening portion that contacts a fastened portion of the cover, wherein one or both of the fastening portion and the fastened portion have an inclined face inclined relative to a fastening direction of the fastener, and the fastening portion and the fastened portion engage with each other through contact at the inclined face in an intersecting direction relative to the fastening direction.

### Effect of the Invention

According to the present invention, the fastener and the cover are engaged with each other through contact at the inclined face in the intersecting direction relative to the fastening direction, thereby suppressing inclination of the spindle shaft.

### BRIEF DESCRIPTION OF THE DRAWINGS

FIG. 1 is a plan view of a recording device according to an embodiment 1 of the present invention.

FIG. 2(A) is a schematic sectional view taken along a line II-II of the recording device of FIG. 1, and FIG. 2(B) is a schematic sectional view of the recording device according to a modified example.

FIG. 3(A) and FIG. 3(B) are schematic sectional views illustrating part of FIG. 2 with enlargement, in which FIG. 3(A) is a state before fastening and FIG. 3(B) is a state after the fastening.

FIG. 4 is a schematic sectional view illustrating part of a recording device according to an embodiment 2 of the present invention.

FIG. 5(A) and FIG. 5(B) are schematic sectional views illustrating part of a recording device with enlargement according to an embodiment 3 of the present invention, in which FIG. 5(A) is a state before fastening and FIG. 5(B) is a state after the fastening.

FIG. 6 is a schematic sectional view illustrating part of the recording device with enlargement according to a modified example of the embodiment 3.

### EMBODIMENT FOR CARRYING OUT THE INVENTION

The object of preventing inclination of a spindle shaft is accomplished by bringing a fastener and a cover into contact with each other through an inclined face.

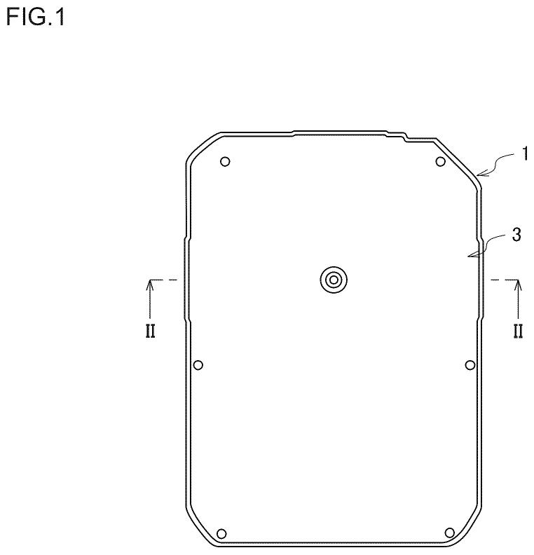

The recording device 1 of the present invention is provided with a base 7, a cover 9, a spindle shaft 15, a fastener 19, inclined faces 27a and 27b as illustrated in FIGS. 1-5.

The base 7 accommodates a recording medium 5 or 10, the cover 9 is attached to the base 7. The spindle shaft 15 rotatably supports the recording medium 5 or 10, one side in an axial direction of which is fixed to the base 7 and the other side in the axial direction of which is fixed to the cover 9. The fastener 19 fixes the other side of the spindle shaft 15 in the axial direction to the cover 9 by fastening and has a fastening portion 21 that contacts a fastened portion 25 of the cover 9. The inclined face 27a, 27b is provided on one or both of the fastening portion 21 and the fastened portion 25, and is inclined relative to a fastening direction of the fastener 19. The fastening portion 21 and the fastened portion 25 engage with each other through contact at the inclined faces 27a and/or 27b in an intersecting direction relative to the fastening direction.

Besides the inclined faces 27a and/or 27b are formed on one or both of the fastening portion 21 and the fastened portion 25, the inclined faces may be formed on a discrete member interposed between the fastening portion 21 and the fastened portion 25.

If the inclined face 27a is formed integrally with the fastened portion 25, the fastened portion 25 may have a taper portion 29 forming the inclined face 27a of the fastened portion 25, a top face of which is inclined relative to the fastening direction. In this case, the fastening portion 21 is provided with a projected portion 31 that is projected toward the fastened portion 25 in the fastening direction and engages with the inclined face 27a of the fastened portion 25 on both sides in the intersecting direction relative to the fastening direction.

Although the tapered portion 29 may be configured to have no resiliency, the tapered portion is preferably configured to have resiliency.

In a case that the tapered portion 29 is configured to have the resiliency, the tapered portion 29 may be a plate member that is projected toward the fastening portion 21 in the fastening direction and is inclined by being resiliently deformed toward the spindle shaft 15, to bring the fastened portion 25 and the fastening portion 21 into resiliently contact with each other through the inclined face 27a.

In a case that the tapered portion 29 is configured to have no resiliency, the spindle shaft 15 may have a projected portion 39 projected in a tapered shape toward the fastening portion 21 in the fastening direction, and the tapered portion 29 may be a plate member inclined along the projected portion 39.

Alternatively, in the tapered portion 29 configured to have the resiliency or to have no resiliency, the spindle shaft 15 may have a recessed portion 41 with a tapered shape formed toward an opposite side relative to the fastening portion 21 in the fastening direction, and the tapered portion 29 may be a plate member inclined along the recessed portion 41. The tapered portion 29 configured to have the resiliency may be inclined by being resiliently deformed toward the spindle shaft 15 in the fastening direction, and may bring the fastening portion 21 and the fastened portion 25 into resiliently contact with each other through the inclined face 27a.

The projected portion 31 may be configured to have resiliency or to have no resiliency.

If the projected portion 31 has the resiliency, the projected portion may be a wall portion that engages with the inclined face 27a of the fastened portion 25 in a state of being resiliently deformed in the intersecting direction relative to the fastening direction and may bring the fastening portion 21 and the fastened portion 25 into resiliently contact with each other through the inclined face 27a.

If the projected portion 31 has no resiliency, the projected portion may be a shaft portion, an outer peripheral face 31a of which is formed into a tapered shape and engages with the recessed portion 41 with intervention of the tapered portion 29.

Further, the projected portion 31 may have the inclined face 27b of the fastening portion 21 contacting the inclined face 27a of the fastened portion 25.

### Embodiment 1

### [Configuration of Recording Device]

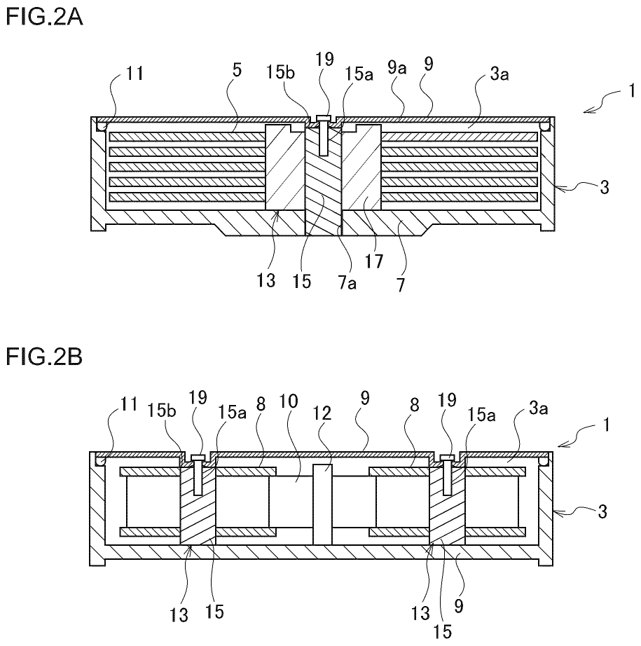

FIG. 1 is a plan view of a recording device according to the embodiment 1 of the present invention. FIG. 2(A) is a schematic sectional view taken along a line II-II of the recording device of FIG. 1, and FIG. 2(B) is a schematic sectional view of the recording device according to a modified example.

A recording device 1 of the present embodiment is a magnetic disk device in which a plurality of disks 5 are accommodated in a space 3a inside a housing 3. The disks 5 form recording media of the present embodiment.

The housing 3 is composed of a base 7 and a cover 9.

The base 7 is made of metal such as aluminum, and is configured into a box shape that is open on one side in a thickness direction of the recording device 1 (hereinafter, simply referred to as “thickness direction”). In addition, the base 7 should be a box shape capable of accommodating the disks 5 and may employ an appropriate shape to the extent. The base 7 of the present embodiment has an approximate rectangular shape in a plan view, for example. In addition, the plan view means a state seen in the thickness direction and does not mean to distinguish a plan and a bottom.

The base 7 is closed by the cover 9 made of metal such as aluminum and attached to the opening on the one side in the thickness direction. A gasket 11 is interposed between the cover 9 and the base 7, thereby sealing the space 3a in the housing 3 accommodating the disks 5.

Gas such as helium having resistance less than of air is sealed in the sealed space 3a, for example. In addition, the space 3a of the housing 3 may be closed by the cover 9 and not be sealed with omission of the gasket 11.

The plurality of the disks 5 are stacked in the thickness direction and are configured to be rotatably supported by a spindle motor 13. These disks 5 are configured so that read/write of information is performed through magnetic heads (not illustrated) positioned by a carriage (not illustrated).

It should be noted that the recording device 1 is not limited to the magnetic disk device and may be the other disk drive such as an optical disk device or the other recording device other than the disk device. For example, the recording device 1 may be a tape-embedded-type drive as illustrated in FIG. 2(B). This recording device 1 accommodates a tape film 10 wound between two tape reels 8 and a head assembly 12 for read/write of information in a housing 3.

The tape film 10 wound between the tape reels 8 forms a recording medium in the tape-embedded-type drive of the modified example. The tape film 10 is rotatably supported by a spindle motor 13 through the respective tape reels 8.

The spindle motor 13 is provided with a spindle shaft 15 and a hub 17. In a case of the tape-embedded-type drive, the spindle motor 13 has no hub 17 and the tape reels 8 cooperate with the spindle shaft 15.

The spindle shaft 15 is a shaft body made of metal such as aluminum and is arranged along the thickness direction. The hub 17 is rotatably supported with the spindle shaft 15. The disks 5 are attached to the hub 17.

The spindle shaft 15, therefore, rotatably supports the disks 5 through the hub 17. In the case of the tape-embedded-type drive, the tape film 10 wound around the tape reel 8 is rotatably supported around the spindle shaft 15.

One side of the spindle shaft 15 in an axial direction is fixed to the base 7 and the other side in the axial direction is fixed to the cover 9.

The fixing to the base 7 may employ an appropriate fixing method. For example, the one side of the spindle shaft 15 in the axial direction is fitted to a hole 7a formed on the base 7 for supporting.

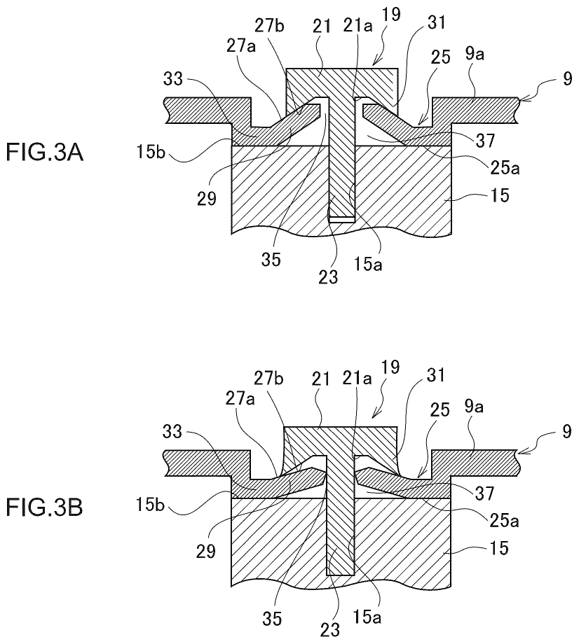

FIG. 3(A) and FIG. 3(B) are schematic sectional views illustrating part of FIG. 2 with enlargement, in which FIG. 3(A) is a state before fastening and FIG. 3(B) is a state after the fastening.

The fixing to the cover 9 is performed by fastening using a screw 19. The screw 19, therefore, forms a fastener of the present embodiment. It should be noted that the fastener may be a female thread member such as nut. In this case, a male thread portion may be provided on the spindle shaft 15.

The screw 19 fixes the spindle shaft 15 to the cover 9 by the fastening. Namely, the screw 19 is provided with a male thread portion 23 protruding from a screw head portion 21. The male thread portion 23 is screwed into a female thread portion 15a provided on the other side of the spindle shaft 15 in the axial direction, thereby bringing the screw head portion 21 into contact with a fastened portion 25 of the cover 9.

The screw head portion 21, therefore, forms a fastening portion of the present embodiment. It should be noted that the fastening portion may be formed by, in a case that the fastener is a female thread portion, the female thread portion as it is.

The fastened portion 25 is provided so as to be bent relative to a peripheral portion 9a of the cover 9. With this, the fastened portion 25 is recessed on a top face facing an outside of the cover 9 and is projected on a bottom face facing an inside of the cover 9. The fastened portion 25 contacts an end face 15b of the spindle shaft 15 on the bottom face 25a and is fastened to the spindle shaft 15.

Inclined faces 27a and 27b are provided on both the fastened portion 25 and the screw head portion 21. It should be noted that an inclined face may be provided on only one of the fastened portion 25 and the screw head portion 21.

The inclined faces 27a and 27b are provided so as to be inclined relative to a fastening direction of the screw 19, and the screw head portion 21 and the fastened portion 25 engage with each other in the thickness direction being the fastening direction and a diametral direction being an intersecting direction relative to the fastening direction through contact at the inclined faces 27a and 27b.

The contact at the inclined faces 27a and 27b is that the screw head portion 21 and the fastened portion 25 contact each other using the inclined faces 27a and 27b sometime from beginning of the fastening until finishing of the fastening. According to the present embodiment, the screw head portion 21 and the fastened portion 25 contact each other through both the inclined faces 27a and 27b at the time of the beginning of the fastening and through only the inclined face 27a at the time of the finishing of the fastening.

The inclined faces 27a and 27b are provided on a tapered portion 29 of the fastened portion 25 and a projected portion 31 of the screw head portion 21, respectively.

The tapered portion 29 is provided at a central portion of the fastened portion 25. A periphery of the tapered portion 29 is provided with a flat plate portion 33 of the fastened portion 25 having a flat plate shape is provided. Both the tapered portion 29 and the flat plate portion 33 are formed by parts of the cover 9 and are made of the plate member forming the cover 9.

The top face of the tapered portion 29 is inclined relative to the thickness direction to form the inclined face 27a of the fastened portion 25. The tapered portion 29 of the present embodiment is formed of a plate member having the same resiliency as the cover 9, and is projected in the thickness direction so as to be gradually reduced in dimension in the diametral direction toward the screw head portion 21. In addition, the diametral direction is a diametral direction of the spindle shaft 15.

The tapered portion 29 is inclined while being resiliently deformed toward the spindle shaft 15 according to contact of the screw head portion 21 after the fastening.

With this, the tapered portion 29 brings the fastened portion 25 and the screw head portion 21 into contact with each other through the inclined face 27a.

According to the present embodiment, the tapered portion 29 is continuously circularly provided around a through-hole 35 passing the male thread portion 23 of the screw 19 therethrough. With this, the tapered portion 29 has a tapered shape on a whole circumference thereof. A space 37 is provided between the tapered portion 29 and the spindle shaft 15. In a range of the space 37, the tapered portion 29 is resiliently deformable.

Although a taper angle of the tapered portion 29 is not particularly limited, the taper angle is in a range that a tip end of the tapered portion 29 is not projected from the peripheral portion 9a of the cover 9 in the thickness direction before the fastening, for example. The tip end of the tapered portion 29 may be, however, projected from the peripheral portion 9a of the cover 9.

It should be noted that the tapered portion 29 may be discontinuously circular shape formed by a plurality of inclined plate members, or may be inclined plate members provided on both sides in the diametral direction in a longitudinal section passing a center of the spindle shaft 15 without a circumferential shape. In the plurality of the inclined plate members, three or more members are, however, preferably provided at regular intervals in the circumferential direction.

The projected portion 31 is projected from the screw head portion 21 toward the fastened portion 25 in the thickness direction, and engages with the inclined face 27a of the fastened portion 25 on both sides in the diametral direction.

The both sides in the diametral direction are both sides relative to the center in the diametral direction in a transverse section of the spindle shaft 15, and include the both sides in the diametral direction in the longitudinal section passing the center of the spindle shaft 15 and do not necessarily mean those both sides. For example, if the projected portion 31 engages with the inclined face 27a of the fastened portion 25 at three points in the circumferential direction or the like, the engaging points should be located on both sides relative to the center in the diametral direction in the transverse section.

The projected portion 31 preferably engages with the inclined face 27a of the fastened portion 25 at three or more points at regular intervals in the circumferential direction. The projected portion 31 of the present embodiment is a wall portion circumferentially formed along an outer edge of the screw head portion 21, and engages with the inclined face 27a of the fastened portion 25 on the whole circumference. It should be noted that the projected portion 31 may be wall portion on an inside relative to the outer edge of the screw head portion 21.

The engagement is conducted through the inclined face 27b of the screw head portion 21 provided on an inner periphery of the projected portion 31 before the fastening. The inclined face 27b contacts the inclined face 27a of the fastened portion 25 in a state just before the fastening.

After the fastening, the engagement to the inclined face 27a of the fastened portion 25 of the projected portion 31 is performed by the tip end portion of the projected portion 31. Namely, the tip end portion of the projected portion 31 engages and contacts with the inclined face 27a of the fastened portion 25 in a resiliently outwardly deformed state in the diametral direction. With this, the inclined face 27b of the screw head portion 21 partly engages with the inclined face 27a of the fastened portion 25 after the fastening.

In addition, the tip end portion of the projected portion 31 includes a tip end of the projected portion 31 and a portion deviated from the tip end toward a base end of the projected portion. Accordingly, it may be configured that only the tip end of the projected portion 31 engages with the inclined face 27a of the fastened portion 25 and the inclined face 27b of the screw head portion 21 does not engage with the inclined face 27a of the fastened portion 25 after the fastening. Although the tip end of the projected portion 31 is an edge with an acute angle, it may be flat or a curved face.

The inclined face 27b of the screw head portion 21 is inclined so as to be gradually increased in diameter toward the fastened portion 25 corresponding to the inclined face 27a of the fastened portion 25. Inclination angles of the inclined faces 27a and 27b are preferably the same as each other. In the inclination angles of the inclined faces 27a and 27b, one may be, however, greater than the other. In addition, the inclined face 27b of the screw head portion 21 may be omitted.

The projected portion 31 engages with the inclined face 27a of the fastened portion 25 in the diametrally resiliently deformed state as mentioned above, and brings the fastened portion 25 and the screw head portion 21 into resiliently contact with each other through at least the inclined face 27a. According to the present embodiment, the fastened portion 25 and the screw 19 resiliently contact each other through the inclined faces 27a and 27b. The projected portion 31 may be, however, configured to engage the inclined face 27a of the fastened portion 25 without resiliently deforming.

### [Fixing Spindle Shaft]

In the recording device 1 of the present embodiment, the one side in the axial direction is fixed to the base 7 and the other end in the axial end is fixed to the cover 9 by fastening using the screw 19 when fixing the spindle shaft 15 as illustrated in FIG. 3.

The one side of the spindle shaft 15 in the axial direction is fixed to the base 7, and the end face 15b contacts the bottom face 25a of the fastened portion 25 of the cover 9 on the other side of the spindle shaft 15 in the axial direction. In this state, the female thread 15a of the spindle shaft 15 faces outside from the through-hole 35 of the fastened portion 25.

The male thread portion 23 of the screw 19 is screwed into the female thread portion 15a through the through-hole 35 of the cover 9. Advancing the screwing, the screw head portion 21 of the screw 19 approaches the fastened portion 25 and the inclined face 27b of the projected portion 31 of the screw head portion 21 comes into contact with the inclined face 27a of the tapered portion 29 of the fastened portion 25.

With this, the spindle shaft 15 is still not fastened to the cover 9 in a before-fastening state. In the before-fastening state, the other side of the spindle shaft 15 in the axial direction is positioned to the cover 9 through the screw 19 and the fastened portion 25 in the diametral direction. The present embodiment, therefore, starts to fasten between the spindle shaft 15 and the cover 9 that are a positioned state in the diametral direction.

Further, in this state, the tip end of the tapered portion 29 has a space with respect to a bottom face 21a of the screw head portion 21 of the screw 19 in the thickness direction. Accordingly, it suppresses inclination, positional deviation or the like of the screw 19 caused by that the tip end of the tapered portion 29 contacts the bottom face 21a of the screw head portion 21. The present embodiment, therefore, allows more surely positioning before the fastening.

Advancing the screwing of the screw 19 in this positioning state, the fastened portion 25 and the cover 9 are fastened by the screw 19. At the time of the fastening, the projected portion 31 and the tapered portion 29 are pushed to each other in the thickness direction to be resiliently deformed.

Namely, the projected portion 31 is pushed to the inclined face 27a of the tapered portion 29 and is resiliently deformed so that the tip end of the projected portion is expanded along the inclined face 27a in the diametral direction.

In the fastened state, both the projected portion 31 and the tapered portion 29 tend to restore by elastic force. With this, the projected portion 31 pushes the inclined face 27a of the tapered portion 29 inward in the diametral direction on the whole circumference, and the tapered portion 29 pushes the projected portion 31 outward in the diametral direction through the inclined face 27a.

With these pushing, the screw head portion 21 is positioned and held with respect to the fastened portion 25 in the diametral direction. The other side of the spindle shaft 15 in the axial direction is, therefore, surely positioned and held with respect to the cover 9 with the elastic force of the projected portion 31 and the tapered portion 29 in the diametral direction.

Further, since the screw 19 is locked by the elastic force of the projected portion 31 and the tapered portion 29 in this state, the other side of the spindle shaft 15 in the axial direction is more surely held.

In this way, the present embodiment positions and surely fixes the axial other side of the spindle shaft 15 with respect to the cover 9 in the diametral direction, so that inclination of the spindle shaft 15 is suppressed if the recording device 1 is impacted.

### Embodiment 2

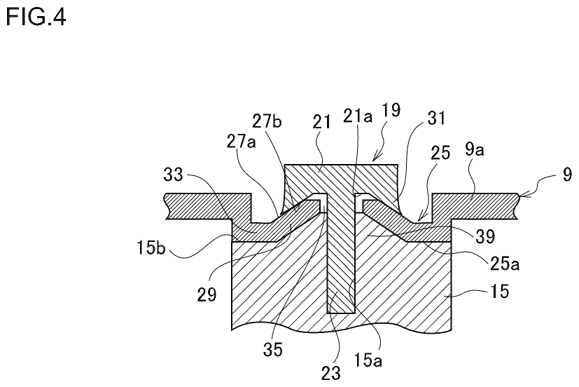

FIG. 4 is a schematic sectional view illustrating part of a recording device according to the embodiment 2 of the present invention with enlargement. In addition, the embodiment 2 is common with the embodiment 1 in the basic structure and corresponding components are represented with the same reference numerals to eliminate duplicate explanation.

The present embodiment makes the tapered portion 29 not being resiliently deformed before and after fastening.

A spindle shaft 15 has a projected portion 39 projected in a tapered shape toward the screw head portion 21 in the thickness direction, the tapered portion 29 of the present embodiment is a plate member inclined along the projected portion 39. The present embodiment is, therefore, different from the embodiment 1 in that the tapered portion 29 is supported with the projected portion 39 of the spindle shaft 15, and others are the same as of the embodiment 1.

In the present embodiment, only the projected portion 31 of the screw head portion 21 is resiliently deformed when the fastened portion 25 and the spindle shaft 15 are fastened by the screw 19. Namely, the projected portion 31 is pushed with respect to the inclined face 27a of the tapered portion 29 similarly to the embodiment 1, and is resiliently deformed so that the tip end of the projected portion expands along the inclined face 27a in the diametral direction. On the other hand, the tapered portion 29 even pushed by the projected portion 31 is prevented by the projected portion 39 of the spindle shaft 15 from being deformed.

Since the projected portion 31 pushes the inclined face 27a of the tapered portion 29 inward in the diametral direction similar to the embodiment 1, even the embodiment 2 provides the same effect as the embodiment 1.

It should be noted that a projected portion with a rectangular sectional shape or the like having no inclined face 27a may be provided on the cover 9 in place of the tapered portion 29 having the tapered portion 27a. In this case, the inclined face 27b of the projected portion 31 conducts contact between the screw head portion 21 and the fastened portion 25.

### Embodiment 3

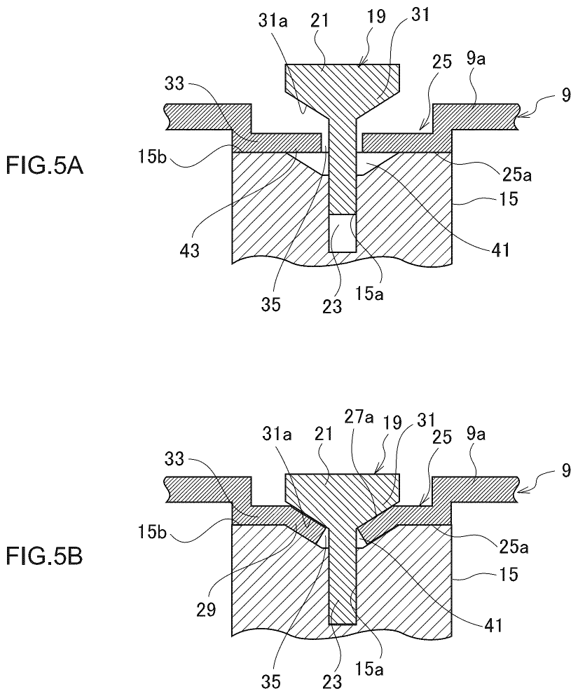

FIG. 5(A) and FIG. 5(B) are schematic sectional views illustrating part of a recording device with enlargement according to the embodiment 3 of the present invention, in which FIG. 5(A) is a state before fastening and FIG. 5(B) is a state after the fastening. In addition, the embodiment 3 is common with the embodiment 1 in the basic structure and corresponding components are represented with the same reference numerals to eliminate duplicate explanation.

The present embodiment forms the tapered portion 29 into a recessed shape toward an opposite side relative to the screw head portion 21. Namely, in the present embodiment, the spindle shaft 15 has a tapered recessed portion 41 formed toward the opposite side relative to the screw head portion 21, and the tapered portion 29 is a plate member inclined along the recessed portion 41.

Further, in the present embodiment, the projected portion 31 is a shaft portion, an outer peripheral face 31a of which is formed into a tapered shape and engages with the recessed portion 41 with intervention of the tapered portion 29. The projected portion 31 is configured not to be resiliently deformed. The tapered angles of the recessed portion 41, the tapered portion 29, and the outer peripheral face 31a of the projected portion 31 are set to be the same.

In a state before fastening, the tapered portion 29 is not formed, and a taper-scheduled portion 43 having a flat plate shape to be the tapered portion 29 is formed around the through-hole 35 so as to continue to the flat plate portion 33. At the time of the fastening, the outer peripheral face 31a of the projected portion 31 makes the taper-scheduled portion 43 be resiliently deformed as the screw 19 is advanced to be screwed.

When the fastening is finished, the outer peripheral face 31a of the projected portion 31 is formed into the tapered shape and engages with the recessed portion 41 with intervention of the tapered portion 29. It should be noted that the tapered portion 29 may be configured in a shape along the recessed shape 41 in advance and not to be resiliently deformed.

In this state, the outer peripheral face 31a that is the inclined face of the projected portion 31 of the screw 19 is pushed by the tapered portion 29 through the inclined face 27a, and it provides the same effect as the embodiment 1. Further, in the case that the tapered portion 29 is caused by resiliently deforming the taper-scheduled portion 43, there is no need to form the tapered portion 29 by processing and manufacture is easily conducted.

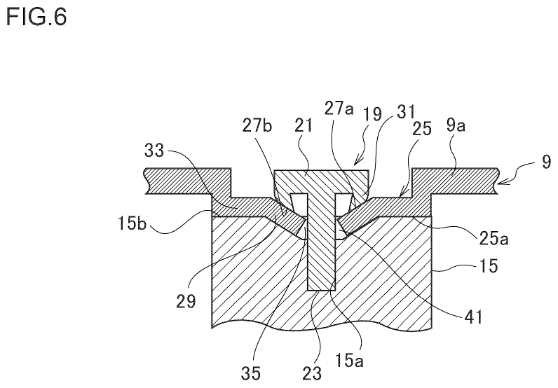

FIG. 6 is a schematic sectional view illustrating part of a recording device with enlargement according to a modified example.

The projected portion 31 may be configured to be resiliently deformable similarly to the embodiment 1 as illustrated in FIG. 6. Namely, the projected portion 31 is a wall portion provided on the outer edge of the screw head portion 21, the outer periphery of the tip end of which is provided with the inclined face 27b.

The projected portion 31 is resiliently deformed together with the taper-scheduled portion 43 when fastening, and the projected portion 31 and the tapered portion 29 resiliently contact each other after the fastening.

The modified example also provides the same effect as the embodiment 3.

### DESCRIPTION OF NUMERALS

1 Recording device
3 Housing
5 Disk (Recording medium)
7 Base
9 Cover
10 Tape film (Recording medium)
15 Spindle shaft
19 Screw (Fastener)
21 Screw head portion (Fastening portion)
25 Fastened portion
27a, 27b Inclined face
29 Tapered portion
31 Projected portion
39 Projected portion
41 Recessed portion

1. A recording device comprising:
a base accommodating a recording medium;
a cover attached to the base;
a spindle shaft rotatably supporting the recording medium, one side in an axial direction of which is fixed to the base and the other side in the axial direction of which is fixed to the cover; and
a fastener fixing said other side of the spindle shaft in the axial direction to the cover by fastening and having a fastening portion that contacts a fastened portion of the cover, wherein
one or both of the fastening portion and the fastened portion have an inclined face inclined relative to a fastening direction of the fastener, and the fastening portion and the fastened portion engage with each other through contact at the inclined face in an intersecting direction relative to the fastening direction.

2. The recording device according to claim 1, wherein
the fastened portion has a tapered portion forming the inclined face of the fastened portion, a top face of which is inclined relative to the fastening direction, and
the fastening portion has a projected portion that is projected toward the fastened portion in the fastening direction and engages with the inclined face of the fastened portion on both sides in the intersecting direction.

3. The recording device according to claim 2, wherein
the tapered portion is formed by a plate member that is projected toward the fastening portion in the fastening direction and is inclined by being resiliently deformed toward the spindle shaft, to bring the fastened portion and the fastening portion into resiliently contact with each other through the inclined face.

4. The recording device according to claim 2, wherein
the spindle shaft has a projected portion projected in a tapered shape toward the fastening portion in the fastening direction, and
the tapered portion is a plate member inclined along the projected portion.

5. The recording device according to claim 2, wherein
the spindle shaft has a tapered recessed portion formed toward an opposite side relative to the fastening portion, and
the tapered portion is a plate member inclined along the recessed portion.

6. The recording device according to claim 5, wherein
the tapered portion is inclined by being resiliently deformed toward the spindle shaft in the fastening direction, and brings the fastening portion and the fastened portion into resiliently contact with each other through the inclined face.

7. The recording device according to any one of claims 2-6, wherein
the projected portion is a wall portion that engages with the inclined face of the fastened portion in a state of being resiliently deformed in the intersecting direction, and brings the fastening portion and the fastened portion into resiliently contact with each other through the inclined face.

8. The recording device according to claim 5 or 6, wherein
the projected portion is a shaft portion, an outer peripheral face of which is formed into a tapered shape and engages with the recessed portion with intervention of the tapered portion.

9. The recording device according to any one of claims 2-6, wherein
the projected portion has the inclined face of the fastening portion contacting the inclined face of the fastened portion.
